(19) United States
(12) Patent Application Publication
(10) Pub. No.: US 2013/0230248 A1
(43) Pub. Date: Sep. 5, 2013

(54) ENSURING VALIDITY OF THE BOOKMARK REFERENCE IN A COLLABORATIVE BOOKMARKING SYSTEM

(71) Applicants: Michael G. Alexander, Austin, TX (US); Paul R. Bastide, Boxford, MA (US); Matthew E. Broomhall, South Burlington, VT (US); Beth Anne M. Collopy, Amesbury, MA (US); Robert E. Loredo, North Miami Beach, FL (US)

(72) Inventors: Michael G. Alexander, Austin, TX (US); Paul R. Bastide, Boxford, MA (US); Matthew E. Broomhall, South Burlington, VT (US); Beth Anne M. Collopy, Amesbury, MA (US); Robert E. Loredo, North Miami Beach, FL (US)

(73) Assignee: International Business Machines Corporation, Armonk, NY (US)

(21) Appl. No.: 13/411,243

(22) Filed: Mar. 2, 2012

(51) Int. Cl. G06F 15/16; G06K 9/18

(52) U.S. Cl. 382/182; 709/205

(57) ABSTRACT

A method, system and computer program product for ensuring that the tags accurately describe a resource referenced by a bookmark in a collaborative bookmarking system. A user bookmarking an Internet resource that is referenced by a bookmark is detected. The user provides a description of the bookmark in the form of metadata, which includes tags, to be associated with the bookmark. The Internet resource is analyzed to determine its meaning. A second user bookmarking the same Internet resource that is referenced by the bookmark is detected. The second user provides a description of the bookmark in the form of metadata, which includes tags. The Internet resource is analyzed a second time to determine its meaning If the relatedness of these meanings is beyond a threshold limit, then the original bookmark metadata is invalidated and the invalidated tags are replaced with the tags provided by the second user.

### TECHNICAL FIELD

The present invention relates to collaborative bookmarking, and more particularly to ensuring the validity of the bookmark reference in a collaborative bookmarking system.

### BACKGROUND

Collaborative bookmarking is a growing phenomenon within the world-wide web. Users of a collaborative bookmarking site contribute to the site by associating, or “tagging,” a bookmark that references a resource, such as web-accessible content via a Uniform Resource Locator (URL), with descriptive phrases and key words, or tags. A tag is a non-hierarchical keyword or term assigned to a piece of information, such as an Internet bookmark, which references a URL. This kind of metadata helps describe the bookmark so that users may understand the content of the resource without first needing to download it for themselves. Tags are chosen informally and personally by the item's creator or by its viewer, depending on the system. On a website in which many users tag many items, this collection of tags becomes a folksonomy, also known as social classification, social indexing or social tagging.

In a collaborative bookmarking system, users save links to the resources (e.g., web pages) that they want to remember and/or share. These bookmarks are usually public, and can be saved privately, shared only with specified people or groups, shared only inside certain networks, or another combination of public and private domains. The allowed people may be able to view these bookmarks by category or tags.

After a person has tagged a bookmark that references a resource, the resource may change. For example, the content of the web page that is referenced by the bookmark may change over a period of time. Hence, the tags that are associated with the bookmark that describe the content of the resource may no longer be an accurate description.

### BRIEF SUMMARY

In one embodiment of the present invention, a method for ensuring that the tags accurately describe a resource referenced by a bookmark in a collaborative bookmarking system comprises detecting a first user bookmarking an Internet resource that is referenced by a bookmark. The method further comprises receiving description in a form of metadata comprising one or more tags to be associated with the bookmark. In addition, the method comprises analyzing the Internet resource a first time to determine a meaning Furthermore, the method comprises detecting a second user bookmarking the Internet resource that is referenced by the bookmark. The method additionally comprises analyzing the Internet resource a second time to determine the meaning In addition, the method comprises invalidating, by a processor, the metadata in response to the meaning determined the second time being different from the meaning determined the first time beyond a first threshold level.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a collaborative bookmarking system configured in accordance with an embodiment of the present invention;

FIG. 2 illustrates a hardware configuration of a collaborative bookmarking server in accordance with an embodiment of the present invention;

FIGS. 3A-3B are a flowchart of a method for ensuring that the tags accurately describe a resource referenced by a bookmark in the collaborative bookmarking system in accordance with an embodiment of the present invention; and

FIG. 4 illustrates a dialog box provided to the user to receive a description of the bookmark in the form of metadata in accordance with an embodiment of the present invention.

### DETAILED DESCRIPTION

The present invention comprises a method, system and computer program product for ensuring that the tags accurately describe a resource referenced by a bookmark in a collaborative bookmarking system. In one embodiment of the present invention, a user bookmarking an Internet resource (e.g., web page) that is referenced by a bookmark is detected. The user provides a description of the bookmark in the form of metadata, which includes tags, to be associated with the bookmark. The Internet resource is analyzed to determine its meaning A second user bookmarking the same Internet resource that is referenced by the bookmark is detected. The second user provides a description of the bookmark in the form of metadata, which includes tags, to be associated with the bookmark. The Internet resource is analyzed a second time to determine its meaning. If the relatedness of these meanings of the Internet resource is beyond a threshold limit, then the original bookmark metadata is invalidated and the invalidated tags are replaced with the tags provided by the second user. In this manner, it can be determined whether the content of the resource has changed to such a degree that the original tags used to describe the content of the resource are no longer valid, and if so, the original tags can be replaced with tags that more accurately describe the resource referenced by the bookmark in the collaborative bookmarking system.

While the following discusses the present invention in connection with the resource referenced by the bookmark being an Internet resource, the principles of the present invention may be applied to any networked resource which the methods of the present invention can access. A person of ordinary skill in the art would be capable of applying the principles of the present invention to such implementations. Further, embodiments applying the principles of the present invention to such implementations would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

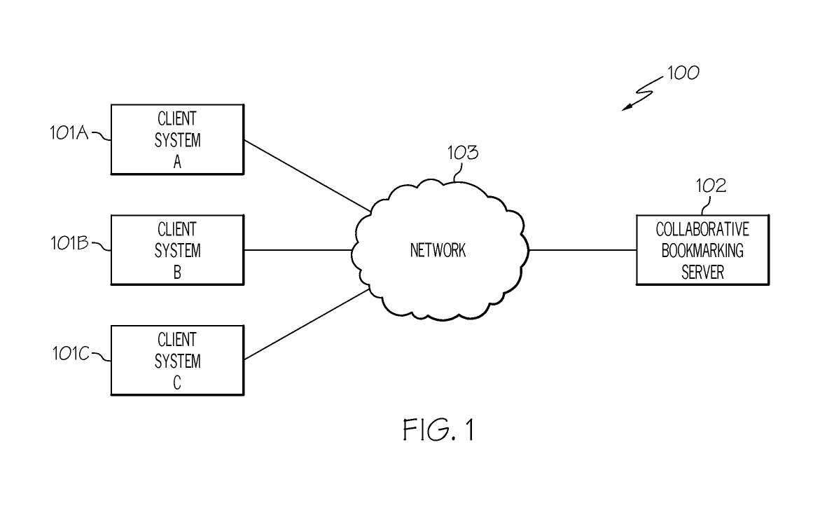

Referring now to the Figures in detail, FIG. 1 illustrates a collaborative bookmarking system 100 for practicing the principles of the present invention in accordance with an embodiment of the present invention. Collaborative bookmarking system 100 includes client systems 101A-101C (identified as “Client System A,” “Client System B,” and “Client System C,” respectively, in FIG. 1) connected to a collaborative bookmarking server 102 via a network 103. Client systems 101A-101C may collectively or individually be referred to as clients 101 or client 101, respectively. Client 101 may be any type of computing device (e.g., portable computing unit, personal digital assistant (PDA), smartphone, laptop computer, mobile phone, navigation device, game console, desktop computer system, workstation, Internet appliance and the like) configured with the capability of connecting to network 103 and consequently communicating with other clients 101 and collaborative bookmarking server 102. Each client 101 is configured to save links to Internet resources (e.g., web pages) that they want to remember and/or share. These bookmarks may be public, and can be saved privately, shared only with specified people or groups, shared only inside certain networks, or another combination of public and private domains. In one embodiment, these bookmarks, along with descriptions of these bookmarks in the form of metadata, may be stored in collaborative bookmarking server 102. In one embodiment, such descriptions may include free text comments, votes in favor of or against its quality, or “tags.” A tag is a non-hierarchical keyword or term assigned to a piece of information, such as an Internet bookmark, which references a Uniform Resource Locator (URL). Tags may be automatically or manually assigned. Such metadata may be used by users (e.g., users of clients 101) to understand the content of the resource referenced by the bookmark without first needing to download the resource themselves.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

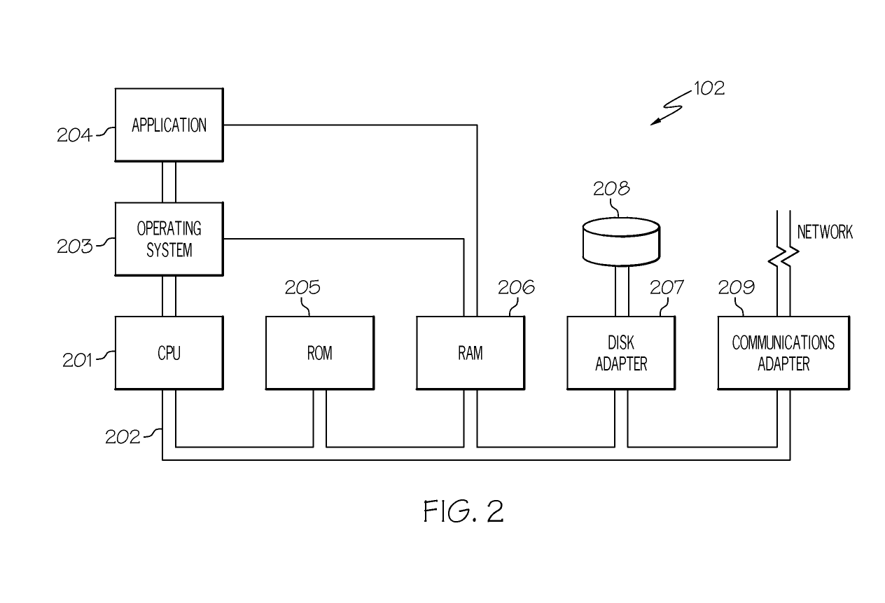

In collaborative bookmarking system 100, collaborative bookmarking server 102 receives new tags from users of clients 101 on various content (content of Internet resource) that the users are viewing on the Internet. A description of the hardware configuration of collaborative bookmarking server 102 is provided below in connection with FIG. 2.

While FIG. 1 illustrates three clients 101A-101C and a single server 102, collaborative bookmarking system 100 may include any number of clients 101 and servers 102. The embodiments of collaborative bookmarking system 100 are not to be limited in scope to the depiction of FIG. 1.

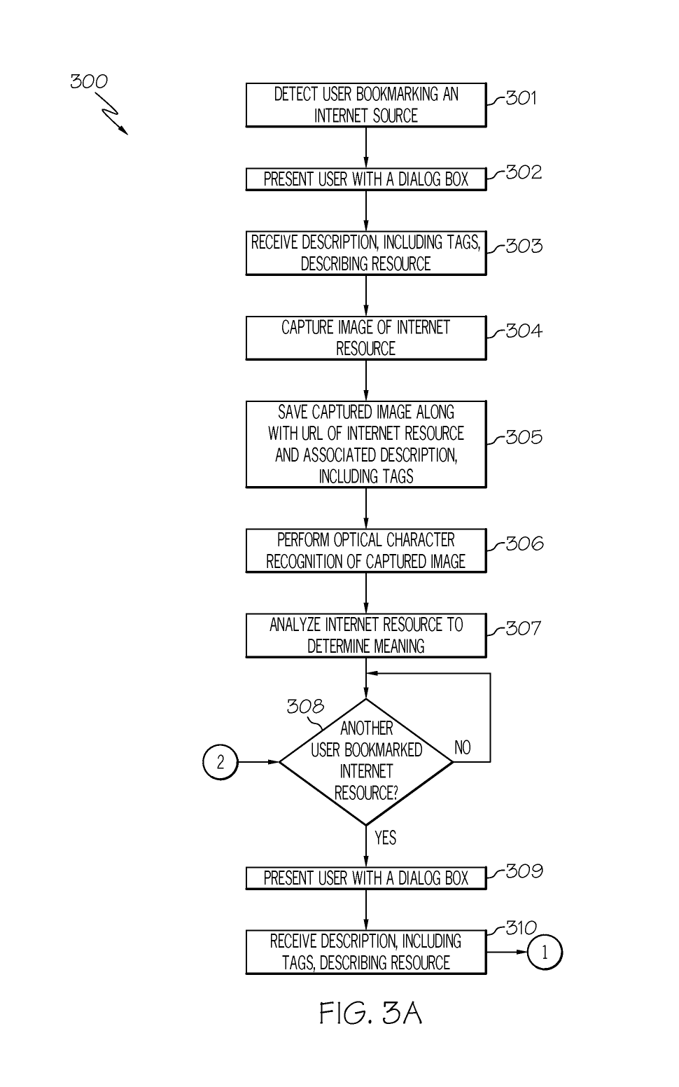

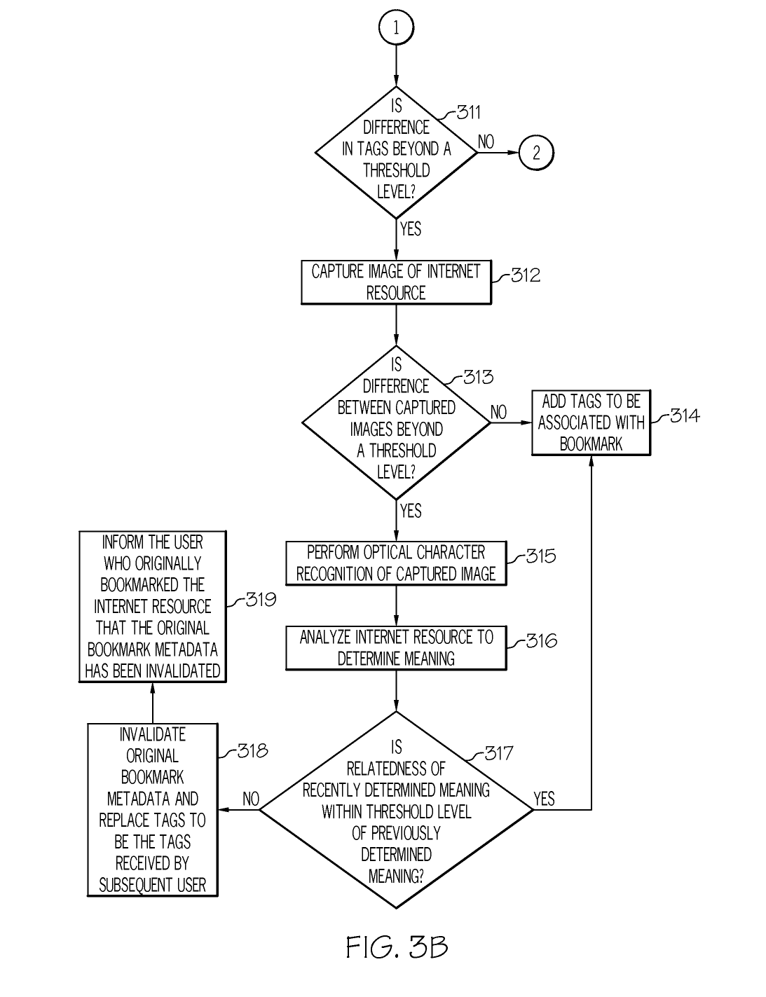

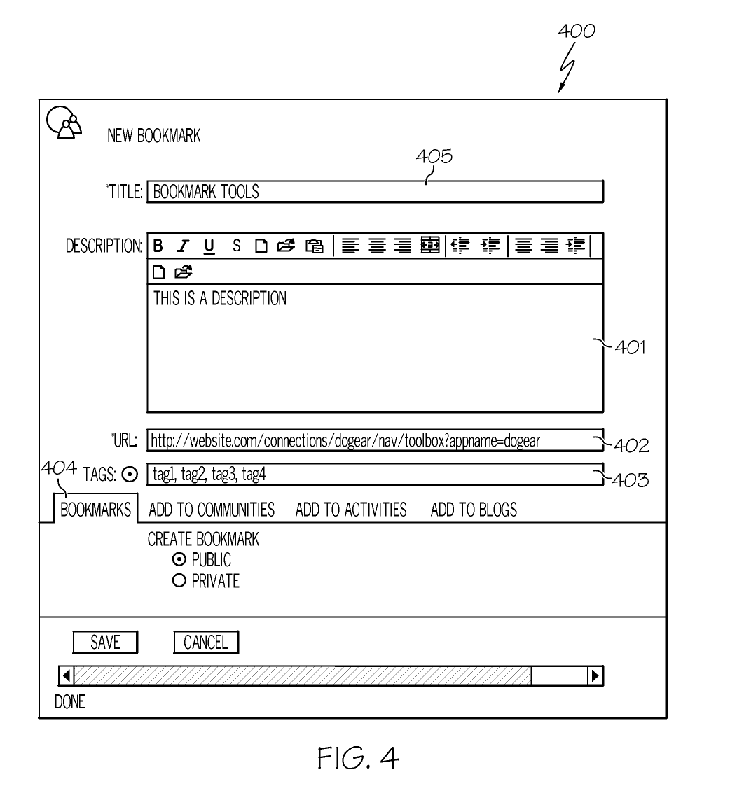

Referring now to FIG. 2, FIG. 2 illustrates a hardware configuration of a collaborative bookmarking server 102 (FIG. 1) which is representative of a hardware environment for practicing the present invention. Referring to FIG. 2, server 102 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for ensuring that the tags accurately describe a resource referenced by a bookmark in a collaborative bookmarking system as discussed further below in association with FIGS. 3A-3B and 4. While the following discusses the program of the present invention (program for ensuring that the tags accurately describe a resource referenced by a bookmark in the collaborative bookmarking system) residing in collaborative bookmarking server 102, the principles of the present invention may be applied to having the program reside in client device 101 (which may be configured similarly as server 102). A person of ordinary skill in the art would be capable of applying the principles of the present invention to such implementations. Further, embodiments applying the principles of the present invention to such implementations would fall within the scope of the present invention.

Referring again to FIG. 2, read-only memory (“ROM”) 205 is coupled to system bus 202 and includes a basic input/output system (“BIOS”) that controls certain basic functions of server 102. Random access memory (“RAM”) 206 and disk adapter 207 are also coupled to system bus 202. It should be noted that software components including operating system 203 and application 204 may be loaded into RAM 206, which may be server's 102 main memory for execution. Disk adapter 207 may be an integrated drive electronics (“IDE”) adapter that communicates with a disk unit 208, e.g., disk drive. It is noted that the program for ensuring that the tags accurately describe a resource referenced by a bookmark in a collaborative bookmarking system, as discussed further below in association with FIGS. 3A-3B and 4, may reside in disk unit 208 or in application 204.

Server 102 may further include a communications adapter 209 coupled to bus 202. Communications adapter 209 interconnects bus 202 with an outside network (network 103) thereby allowing server 102 to communicate with clients 101.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, in a collaborative bookmarking system, users save links to the resources (e.g., web pages) that they want to remember and/or share. These bookmarks are usually public, and can be saved privately, shared only with specified people or groups, shared only inside certain networks, or another combination of public and private domains. The allowed people may be able to view these bookmarks by category or tags. After a person has tagged a bookmark that references a resource, the resource may change. For example, the content of the web page that is referenced by the bookmark may change over a period of time. Hence, the tags that are associated with the bookmark that describe the content of the resource may no longer be an accurate description.

The principles of the present invention provide a means for ensuring that the tags accurately describe the resource referenced by the bookmark in the collaborative bookmarking system as discussed further below in connection with FIGS. 3A-3B and 4. FIGS. 3A-3B are a flowchart of a method for ensuring that the tags accurately describe a resource referenced by a bookmark in the collaborative bookmarking system. FIG. 4 illustrates a dialog box provided to the user to receive a description of the bookmark in the form of metadata.

As stated above, FIGS. 3A-3B are a flowchart of a method 300 for ensuring that the tags accurately describe a resource referenced by a bookmark in the collaborative bookmarking system in accordance with an embodiment of the present invention.

Referring to FIG. 3A, in conjunction with FIGS. 1-2, in step 301, collaborative bookmarking server 102 detects a user bookmarking an Internet resource (e.g., web page) that is referenced by a bookmark (a Uniform Resource Locator (URL) that may be stored locally on client 101).

In step 302, collaborative bookmarking server 102 presents a user with a dialog box to enter a description about the bookmark in the form of metadata. The description may include free text comments, votes in favor of or against its quality as well as tags. As discussed above, a tag is a non-hierarchical keyword or term assigned to a piece of information, such as an Internet bookmark, which references a URL. An illustration of such a dialog box is provided in FIG. 4.

FIG. 4 illustrates a dialog box 400 provided to the user to receive a description of the bookmark in the form of metadata in accordance with an embodiment of the present invention. Referring to FIG. 4, dialog box 400 includes a section 401 to enter text comments concerning the Internet resource, which is referenced by URL 402. Also, dialog box 400 includes a section 403 to enter tags to describe the reference. The user may be provided an option in tab 404 as to whether the bookmark is to be public or private. Also, the user may be provided an option to enter the title of the bookmark in the title bar 405.

Returning to FIG. 3A, in conjunction with FIGS. 1-2, in step 303, collaborative bookmarking server 102 receives the description of the bookmark, including tags, that describe the resource as discussed above in connection with FIG. 4.

In step 304, collaborative bookmarking server 102 captures an image of the Internet resource. That is, collaborative bookmarking server 102 captures an image of the web page that is referenced by the bookmark. In one embodiment, the captured image may be displayed as a thumbnail of a page. In one embodiment, collaborative bookmarking server 102 captures embedded video content within the Internet resource which may be used for analyzing the Internet resource to determine its meaning as discussed further below.

In step 305, collaborative bookmarking server 102 saves the captured image along with the URL of the Internet resource and associated description, including the tags. In one embodiment, such information may be stored in disk unit 208. In another embodiment, such information may be stored in a database connected to server 102. In one embodiment, the captured image may be stored as a personalized thumbnail.

In step 306, collaborative bookmarking server 102 performs optical character recognition of the captured image in order to translate the image into machine-encoded text so that the Internet resource can be analyzed to determine its meaning Determining the meaning of a captured image (also referred to herein as “intent analysis”) refers to inferring the meaning that the author intended to convey in the captured image. For example, if the captured image was an article on a Republican primary debate held in Florida on Jan. 26, 2012, then the meaning of the captured image that can be inferred is a debate between Republican candidates that was held on Jan. 26, 2012. In one embodiment, the intent analysis includes language identification, semantic analysis, disambiguation, detecting unique textual elements, weighing the proportional height of characters for the page (e.g., larger font size may receive a higher weight) and so forth. In one embodiment, the intent analysis may leverage the use of natural language processing technology. In one embodiment, the intent analysis may further be performed on video content, such as video content embedded within the Internet resource. For example, content may be provided in the sub-channel of the video, such as in the form of closed captioning, which may be used to infer the meaning of the video content. In another example, each frame within the video content/video stream may be treated as a captured image and dynamically analyzed to determine its meaning Additionally, each frame may be associated with audio, where the audio may be converted to text and used to infer the meaning of the frame. Other information that may be embedded within the video stream may be used to infer the meaning of the video content, such as location information.

In step 307, collaborative bookmarking server 102 analyzes the machine-encoded text of the captured image (i.e., analyzing the Internet resource) to determine its meaning as discussed above. In one embodiment, such analysis may be performed during non-peak times.

In step 308, a determination is made by collaborative bookmarking server 102 as to whether another user has bookmarked the same Internet resource. If another user has not bookmarked the same Internet resource, then collaborative bookmarking server 102 continues to determine whether another user has bookmarked the same Internet resource in step 308.

If, however, another user has bookmarked the same Internet resource, then, in step 309, collaborative bookmarking server 102 presents the subsequent user with a dialog box 400, similarly as discussed above in connection with step 302.

In step 310, collaborative bookmarking server 102 receives from the subsequent user the description of the bookmark, including tags, via the subsequent user entering such information in dialog box 400 as discussed above in connection with FIG. 4.

Referring to FIG. 3B, in conjunction with FIGS. 1-2, in step 311, a determination is made by collaborative bookmarking server 102 as to whether the tags received by the subsequent user in step 310 are different from the tags received by the original user in step 303 beyond a threshold level.

If the tags are not different beyond a threshold level, then collaborative bookmarking server 102 continues to determine whether another user has bookmarked the same Internet resource in step 308.

If, however, the tags are different beyond the threshold level, then, in step 312, collaborative bookmarking server 102 captures a further image of the Internet resource. That is, collaborative bookmarking server 102 captures a subsequent image of the web page that is referenced by the bookmark. In one embodiment, the captured image may be displayed as a thumbnail of a page. In one embodiment, collaborative bookmarking server 102 captures embedded video content within the Internet resource which may be used for analyzing the Internet resource to determine its meaning as discussed above.

In step 313, a determination is made by collaborative bookmarking server 102 as to whether the difference between the captured images (image captured in step 312 and the image captured in step 304) is beyond a threshold level.

If the difference is not beyond a threshold level (or there is no difference at all), then, in step 314, collaborative bookmarking server 102 adds the tags received by the subsequent user in step 310 to be associated with the bookmark.

If, however, the difference between the captured images (image captured in step 312 and the image captured in step 304) is beyond a threshold level, then, in step 315, collaborative bookmarking server 102 performs a further optical character recognition of the captured image (image captured in step 312) in order to translate the image into machine-encoded text so that the Internet resource can be analyzed to determine its meaning

In step 316, collaborative bookmarking server 102 analyzes the machine-encoded text of the captured image (image captured in step 312) (i.e., analyzing the Internet resource) to determine its meaning as discussed above. In one embodiment, such analysis may be performed during non-peak times.

In step 317, a determination is made by collaborative bookmarking server 102 to determine whether the relatedness of the meaning determined in step 316 is within the threshold level of the meaning determined in step 307. In this manner, it can be determined whether the content of the resource has changed to such a degree that the original tags (associated with the bookmark that references the resource) used to describe the content of the resource are no longer valid.

If the relatedness of the meaning determined in step 316 is within the threshold level of the meaning determined in step 307, then collaborative bookmarking server 102 adds the tags received by the subsequent user in step 310 to be associated with the bookmark in step 314.

If, however, the relatedness of the meaning determined in step 316 is not within the threshold level of the meaning determined in step 307, then, in step 318, collaborative bookmarking server 102 invalidates the original bookmark metadata, including the original tags, and replaces the original tags with the tags received by the subsequent user in step 310 so that the tags associated with the bookmark accurately describe the content of the referenced resource. In this manner, collaborative bookmarking server 102 ensures that the tags accurately describe the resource referenced by the bookmark in the collaborative bookmarking system.

In step 319, collaborative bookmarking server 102 informs the user who originally bookmarked the Internet resource that the original bookmark metadata has been invalidated.

In some implementations, method 300 may include other and/or additional steps that, for clarity, are not depicted. Further, in some implementations, method 300 may be executed in a different order presented and that the order presented in the discussion of FIGS. 3A-3B is illustrative. Additionally, in some implementations, certain steps in method 300 may be executed in a substantially simultaneous manner or may be omitted.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for ensuring that the tags accurately describe a resource referenced by a bookmark in a collaborative bookmarking system, the method comprising:
detecting a first user bookmarking an Internet resource that is referenced by a bookmark;
receiving description in a form of metadata comprising one or more tags to be associated with said bookmark;
analyzing said Internet resource a first time to determine a meaning;
detecting a second user bookmarking said Internet resource that is referenced by said bookmark;
analyzing said Internet resource a second time to determine said meaning; and
invalidating, by a processor, said metadata in response to said meaning determined said second time being different from said meaning determined said first time beyond a first threshold level.

2. The method as recited in claim 1 further comprising:
receiving one or more additional tags to be associated with said bookmark from said second user; and
replacing said invalidated one or more tags with said one or more additional tags.

3. The method as recited in claim 1 further comprising:
capturing a first image of said Internet resource; and
performing a first optical character recognition of said first captured image of said Internet resource.

4. The method as recited in claim 3 further comprising:
analyzing said Internet resource said first time to determine said meaning by analyzing said first captured image of said Internet resource after said first optical character recognition is performed on said first captured image of said Internet resource.

5. The method as recited in claim 3 further comprising:
receiving one or more additional tags to be associated with said bookmark;
capturing a second image of said Internet resource in response to said one or more additional tags being different from said one or more tags beyond a second threshold level; and
performing a second optical character recognition of said second captured image of said Internet resource in response to said second captured image being different from said first captured image beyond a third threshold level.

6. The method as recited in claim 5 further comprising:
analyzing said Internet resource said second time to determine said meaning by analyzing said second captured image of said Internet resource after said second optical character recognition is performed on said second captured image of said Internet resource; and
adding said one or more additional tags to be associated with said bookmark in response to said meaning determined said second time not being different from said meaning determined said first time beyond said first threshold level.

7. The method as recited in claim 3 further comprising:
receiving one or more additional tags to be associated with said bookmark;
capturing a second image of said Internet resource in response to said one or more additional tags being different from said one or more tags beyond a second threshold level; and
adding said one or more additional tags to be associated with said bookmark in response to said second captured image not being different from said first captured image beyond a third threshold level.

8. A computer program product embodied in a computer readable storage medium for ensuring that the tags accurately describe a resource referenced by a bookmark in a collaborative bookmarking system, the computer program product comprising the programming instructions for:
detecting a first user bookmarking an Internet resource that is referenced by a bookmark;
receiving description in a form of metadata comprising one or more tags to be associated with said bookmark;
analyzing said Internet resource a first time to determine a meaning;
detecting a second user bookmarking said Internet resource that is referenced by said bookmark;
analyzing said Internet resource a second time to determine said meaning; and
invalidating said metadata in response to a relatedness of said meaning determined said second time being different from said meaning determined said first time beyond a first threshold level.

9. The computer program product as recited in claim 8 further comprising the programming instructions for:
receiving one or more additional tags to be associated with said bookmark from said second user; and
replacing said invalidated one or more tags with said one or more additional tags.

10. The computer program product as recited in claim 8 further comprising the programming instructions for:
capturing a first image of said Internet resource; and
performing a first optical character recognition of said first captured image of said Internet resource.

11. The computer program product as recited in claim 10 further comprising the programming instructions for:
analyzing said Internet resource said first time to determine said meaning by analyzing said first captured image of said Internet resource after said first optical character recognition is performed on said first captured image of said Internet resource.

12. The computer program product as recited in claim 10 further comprising the programming instructions for:
receiving one or more additional tags to be associated with said bookmark;
capturing a second image of said Internet resource in response to said one or more additional tags being different from said one or more tags beyond a second threshold level; and
performing a second optical character recognition of said second captured image of said Internet resource in response to said second captured image being different from said first captured image beyond a third threshold level.

13. The computer program product as recited in claim 12 further comprising the programming instructions for:
analyzing said Internet resource said second time to determine said meaning by analyzing said second captured image of said Internet resource after said second optical character recognition is performed on said second captured image of said Internet resource; and
adding said one or more additional tags to be associated with said bookmark in response to said relatedness of said meaning determined said second time not being different from said meaning determined said first time beyond said first threshold level.

14. The computer program product as recited in claim 10 further comprising the programming instructions for:
receiving one or more additional tags to be associated with said bookmark;
capturing a second image of said Internet resource in response to said one or more additional tags being different from said one or more tags beyond a second threshold level; and
adding said one or more additional tags to be associated with said bookmark in response to said second captured image not being different from said first captured image beyond a third threshold level.

15. A system, comprising:
a memory unit for storing a computer program for ensuring that the tags accurately describe a resource referenced by a bookmark in a collaborative bookmarking system; and
a processor coupled to said memory unit, wherein said processor, responsive to said computer program, comprises:
circuitry for detecting a first user bookmarking an Internet resource that is referenced by a bookmark;
circuitry for receiving description in a form of metadata comprising one or more tags to be associated with said bookmark;
circuitry for analyzing said Internet resource a first time to determine a meaning;
circuitry for detecting a second user bookmarking said Internet resource that is referenced by said bookmark;
circuitry for analyzing said Internet resource a second time to determine said meaning; and
circuitry for invalidating said metadata in response to a relatedness of said meaning determined said second time being different from said meaning determined said first time beyond a first threshold level.

16. The system as recited in claim 15, wherein said processor further comprises:
circuitry for receiving one or more additional tags to be associated with said bookmark from said second user; and
circuitry for replacing said invalidated one or more tags with said one or more additional tags.

17. The system as recited in claim 15, wherein said processor further comprises:
circuitry for capturing a first image of said Internet resource; and
circuitry for performing a first optical character recognition of said first captured image of said Internet resource.

18. The system as recited in claim 17, wherein said processor further comprises:
circuitry for analyzing said Internet resource said first time to determine said meaning by analyzing said first captured image of said Internet resource after said first optical character recognition is performed on said first captured image of said Internet resource.

19. The system as recited in claim 17, wherein said processor further comprises:
circuitry for receiving one or more additional tags to be associated with said bookmark;
circuitry for capturing a second image of said Internet resource in response to said one or more additional tags being different from said one or more tags beyond a second threshold level; and
circuitry for performing a second optical character recognition of said second captured image of said Internet resource in response to said second captured image being different from said first captured image beyond a third threshold level.

20. The system as recited in claim 17, wherein said processor further comprises:
circuitry for receiving one or more additional tags to be associated with said bookmark;
circuitry for capturing a second image of said Internet resource in response to said one or more additional tags being different from said one or more tags beyond a second threshold level; and
circuitry for adding said one or more additional tags to be associated with said bookmark in response to said second captured image not being different from said first captured image beyond a third threshold level.
